(19) United States
(12) Patent Application Publication
(10) Pub. No.: US 2026/0178255 A1
(43) Pub. Date: Jun. 25, 2026

(54) AUTOMATIC DISPLAY ALIGNMENT USING FEATURE TRACKING

(71) Applicant: Apple Inc., Cupertino, CA (US)

(72) Inventors: Tim H. Cornelissen, San Francisco, CA (US); Jiaying Wu, Woodside, CA (US); Jonathan C. Moisant-Thompson, San Jose, CA (US); Julian Quintana, San Diego, CA (US); Rakshit S. Kothari, Santa Clara, CA (US); Ethan T. Daniels, Los Gatos, CA (US)

(21) Appl. No.: 19/428,073

(22) Filed: Dec. 19, 2025

Related U.S. Application Data
(60) Provisional application No. 63/738,471, filed on Dec. 23, 2024.

(51) Int. Cl. G06F 3/14; G06T 7/73

(52) U.S. Cl. CPC G06F 3/1423; G06T 7/74; G06T 2207/30244

(57) ABSTRACT

Embodiments are disclosed for automatic display alignment using feature tracking. In some embodiments, a method comprises: capturing, with a first camera of a first display, a first image; capturing, with a second camera of a second display, a second image, where the respective fields of view for the first camera and the second camera are at least partially overlapped; transforming the first head pose into a first reference frame for the first display; transforming the second head pose into a second reference frame for the second display; generating a dual-display environment for the first and second displays based on the first and second head poses in the first and second reference frames, respectively; presenting a first portion of the dual-display environment on the first display; and presenting a second portion of the dual-display environment on the second display.

### CROSS-REFERENCE TO RELATED APPLICATION

This application claims priority to U.S. Provisional Patent Application No. 63/738,471, filed Dec. 23, 2024, the entire contents of which are incorporated herein by reference.

### TECHNICAL FIELD

This disclosure relates generally to workstations, and more particularly to aligning multiple displays of a workstation.

### BACKGROUND

Users will often use more than one computer display to expand the screen space of their workstation for various applications. Typically, an external display is added to the workstation as a stand-alone display or a built-in display of another device, such as a notebook computer or tablet computer. It is often desirable for the two displays to behave like a single display for various operating system functions, such as cursor navigation and backgrounds (e.g., wallpaper, screensavers, etc.). For example, if the user has an external notebook computer display located to the right of their desktop computer display, and the user navigates the cursor across the right side boundary of the desktop computer display, it is desirable that after crossing the screen boundary of the first display that the cursor movement is predictable, such that it maintains the same trajectory (speed and direction) when the cursor appears on the second display and vice-versa. However, this may not be the result if the operating system does not know the positions of the two displays relative to each other.

Existing alignment solutions require the user to manually inform the operating system of the relative positions of the displays. For example, the macOS® operating system developed by Apple Inc. of Cupertino, California, provides a settings option that allows the user to manually arrange display icons representing the displays. To arrange the displays, the user drags the display icons to a desired relative position to each other in a settings pane. For example, the user may drag the icon for an external display to the right side of the icon for a desktop computer display. Although tech savvy users may know how to use this settings option, many others do not. This can result in a significant number of calls to the developer's support service by users requesting help on how to set up an external display.

### SUMMARY

Embodiments are disclosed for automatic display alignment using feature tracking.

In some embodiments, a method comprises: capturing, with a first camera of a first display, a first image; capturing, with a second camera of a second display, a second image, where the respective fields of view for the first camera and the second camera are at least partially overlapped; transforming, with at least one processor, the first head pose into a first reference frame for the first display; transforming, with the at least one processor, the second head pose into a second reference frame for the second display; generating, with the at least one processor, a dual-display environment for the first and second displays based on the first and second head poses in the first and second reference frames, respectively; presenting, with the at least one processor, a first portion of the dual-display environment on the first display; and presenting, with the at least one processor, a second portion of the dual-display environment on the second display.

In some embodiments, the method further comprises: presenting, with the at least one processor, a first portion of wallpaper or screensaver on the first display; and presenting, with the at least one processor, a second portion of the wallpaper or screensaver on the second display.

In some embodiments, the first display and second display are side by side.

In some embodiments, the first display is a desktop computer display with a first set of dimensions and the second display is a notebook computer display with a second set of dimensions that are smaller than the first set of dimensions.

In some embodiments, transforming the first head pose into the first reference frame for the first display, and transforming the second head pose into the second reference frame for the second display comprises: for the first display: transforming the first head pose into a first camera frame; obtaining a head frame to first camera frame transformation using intrinsic parameters of the first camera; inverting the head frame to first camera frame transformation into a first camera frame to head frame transformation; obtaining a first display frame to first camera frame transformation using extrinsic parameters of the first display; obtaining a first display frame to head frame transformation based on the first camera frame to head frame transformation and the first display frame to first camera frame transformation; transforming, using the first display frame to head frame transformation, the first head pose into the head frame; for the second display: transforming the second head pose into a second camera frame; obtaining a head frame to second camera frame transformation using intrinsic parameters of the second camera; inverting the head frame to second camera frame transformation into a second camera frame to head frame transformation; obtaining a second display frame to second camera frame transformation using extrinsic parameters of the second display; obtaining a second display frame to head frame transformation based on the second camera frame to head frame transformation and the second display frame to second camera frame transformation; transforming, using the second display frame to head frame transformation, the first head pose into the head frame; determining relative positions of centers of the first and second displays in the head frame based on positions and orientations of the first and second head poses in the head frame; mapping a background image to a two-dimensional (2D) virtual flat plane based on the relative positions of the first and second displays and their respective dimensions; cutting out a first portion of the 2D virtual flat plane based on a first set of dimensions of the first display; cutting out a second portion of the 2D virtual flat plane based on a second set of dimensions of the second display; and presenting the first portion on the first display and the second portion on the second display.

In some embodiments, determining relative positions of centers of the first and second displays in the head frame based on positions and orientations of the first and second head poses in the head frame includes determining angles of head pose vectors in the head frame that point from the head to the centers of the first and second displays.

In some embodiments, a gap between the first and second displays is removed during the cutting of the first and second portions from the 2D virtual flat plane.

Particular embodiments described herein provide one or more of the following advantages. Computers with cameras and feature tracking can automatically align two or more displays for an improved user experience and also reduce the demand on support resources.

### BRIEF DESCRIPTION OF THE DRAWINGS

FIG. 1A illustrates cursor navigation across adjacent displays, according to one or more embodiments.

FIG. 1B illustrates the presentation of a background across adjacent displays, according to one or more embodiments.

FIG. 2 is a flow diagram of a process of automatic display alignment using face tracking, according to one or more embodiments.

FIGS. 3A and 3B illustrate reconstruction of a home screen using the process of FIG. 2, according to one or more embodiments.

FIG. 4 illustrates representing the relative position of two displays in a head reference frame, according to one or more embodiments.

FIG. 5 illustrates mapping a background to multiple displays based on their relative positions to each other and dimensions, according to one or more embodiments.

FIG. 6 illustrates an alternative embodiment of display alignment using environment feature tracking, according to one or more embodiments.

FIG. 7 is a block diagram of a system for implementing the processes described in reference to FIGS. 1-6.

### DETAILED DESCRIPTION

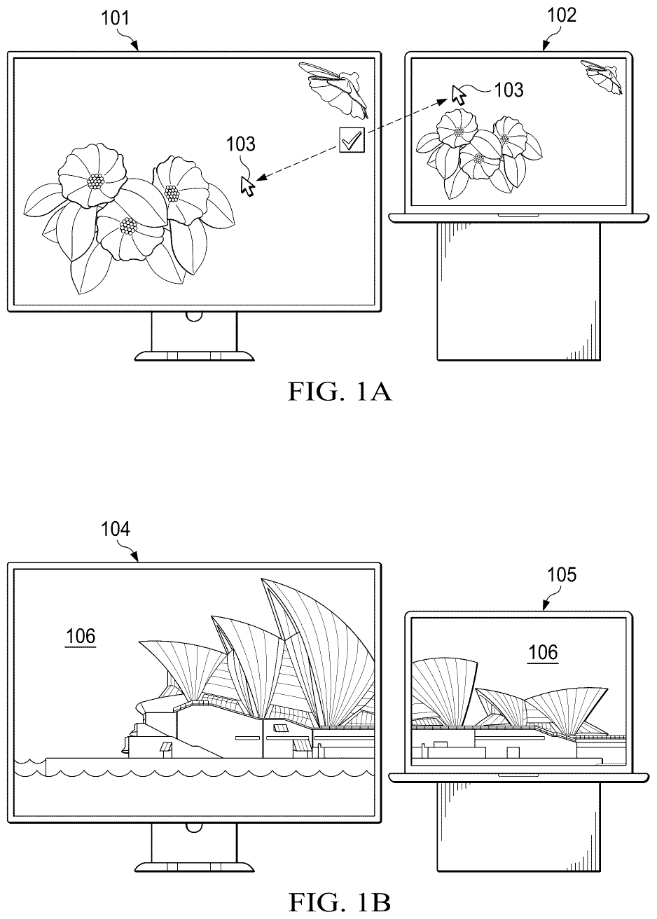

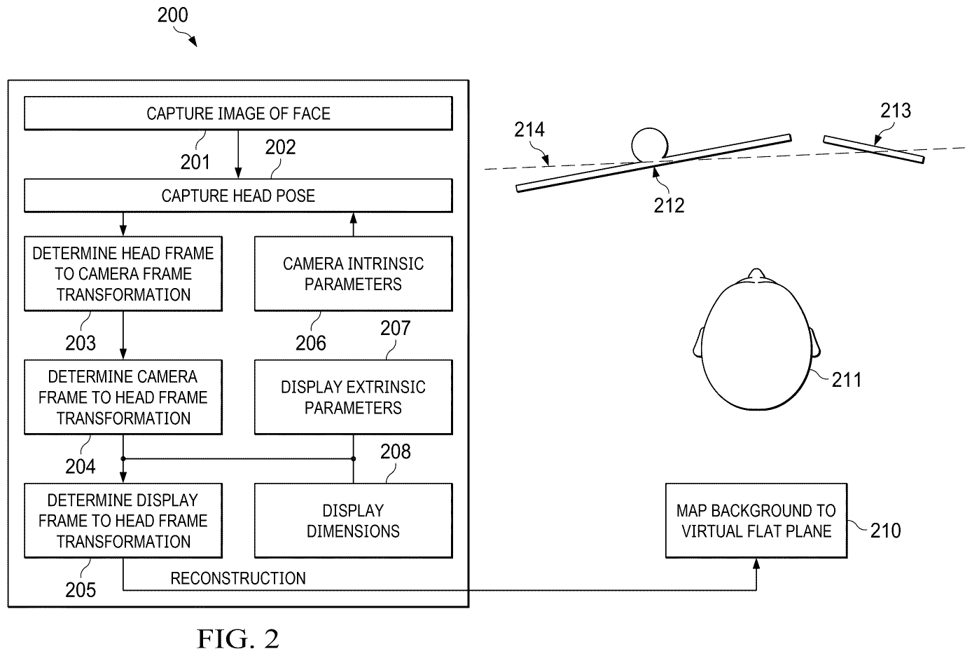

FIG. 1A illustrates cursor navigation across adjacent displays, according to one or more embodiments. In this example, notebook computer display 102 is placed to the right of desktop computer display 101. If displays 101 and 102 are aligned than the user can move cursor 103 from display 101 to display 102 and cursor 103 is presented on display 102 in a predictable manner, such as maintaining the same trajectory (shown as a dashed line) after crossing the gap between displays 101 and 102.

FIG. 1B illustrates the presentation of a background 106 across adjacent displays 104 and 105, according to one or more embodiments. In this example, desktop computer display 104 is placed next to notebook computer display 105. If displays 104 and 105 are aligned than background 106 (e.g., wallpaper, screensaver) is presented across displays 104 and 105 as if they were one large display.

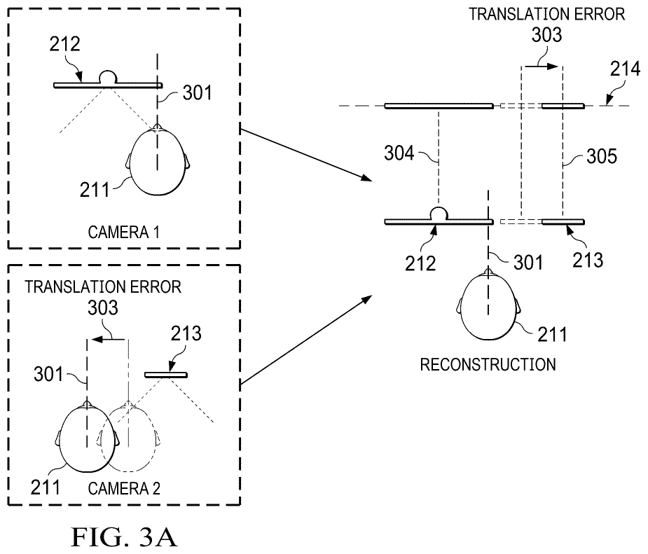

FIG. 2 is a flow diagram of process 200 of automatic display alignment using face tracking, according to one or more embodiments. Process 200 shown in FIG. 2 is performed by one computer and camera but should be understood that the same process 200 is also performed by the second device and camera (e.g., a desktop computer/camera and notebook computer/camera, two desktop computers/cameras, two notebook computer/cameras, a notebook computer/camera and tablet computer/camera, etc.).

Process 200 begins when an image of the user's face 201 is captured by a camera attached to, or embedded in, the first display 212. Face tracker 202 receives captured image 201 and computes the position and orientation of user's head 211 in a camera reference frame. Face tracker 202 also provides a head frame to camera frame transformation,

$${T}_{H}^{C} ,$$

using intrinsic parameters 206 of camera 203. An example face tracker 202 is part of ARKit®, which is an augmented reality (AR) developer framework for the macOS® operating system.

This transformation is inverted 204 to provide a camera frame to head frame transformation,

$${T}_{C}^{H} .$$

A display frame to camera frame transformation,

$${T}_{D}^{C} ,$$

is computed 205 using display extrinsic parameters 206 (rotation and translation parameters), which are typically fixed for a display camera and are mathematical representations of the translation and rotation of the display frame relative to the camera frame.

Assuming that the transformations are in matrix form (direction cosine matrix), then a display frame to head frame transformation,

$${T}_{D}^{H} ,$$

is computed by multiplying the camera frame to head frame transformation matrix,

$${T}_{C}^{H} ,$$

by the display frame to camera frame transformation matrix,

$${T}_{D}^{C} .$$

This calculation is shown in Equation [1] below:

$${T}_{D}^{H} = {T}_{C}^{H} {T}_{D}^{C} . \qquad [ 1 ]$$

Using the transformation,

$${T}_{D}^{H} ,$$

the user's head pose (position and orientation) provided by the face tracker 203 can be transformed into the head frame. Accordingly,

$${T}_{D}^{H}$$

is a common reference coordinate frame for head poses captured by the two cameras with at least partially overlapping field of views (FOVs).

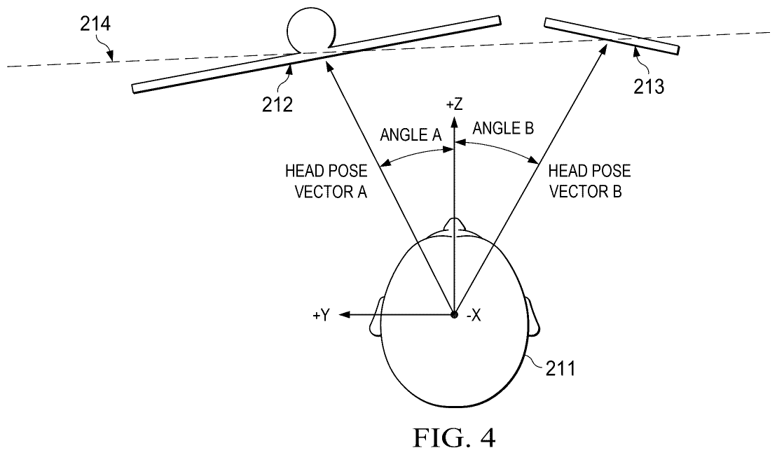

The user's head pose position and orientation vectors computed by face tracker 202 are rotated into the head frame using

$${T}_{D}^{H}$$

where the vectors are used to determine the relative positions of displays 212, 213 in the head frame, as described in reference to FIG. 4.

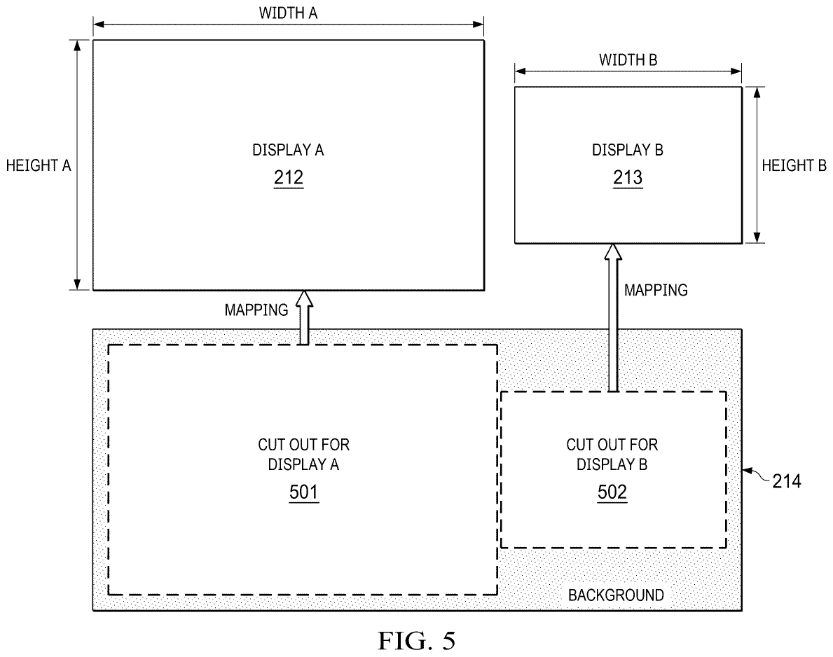

With the relative positions of displays 212, 213 determined and their known respective dimensions 208 (width, height), a background can be mapped 210 to a two-dimensional (2D) virtual flat plane 214, which is used to determine how the background will span over displays 212, 213, as described in reference to FIG. 5. Different portions of the 2D virtual flat plane 214 are then cut-out for simultaneous presentation on displays 212, 213 in accordance with their respective dimensions 208, resulting in the effect shown in FIG. 1B.

Note that the transformations described above can be represented as direction cosine matrices or as quaternions. Using quaternions reduces the number of parameters in the transformation calculations, thereby increasing the speed of the transformation calculations.

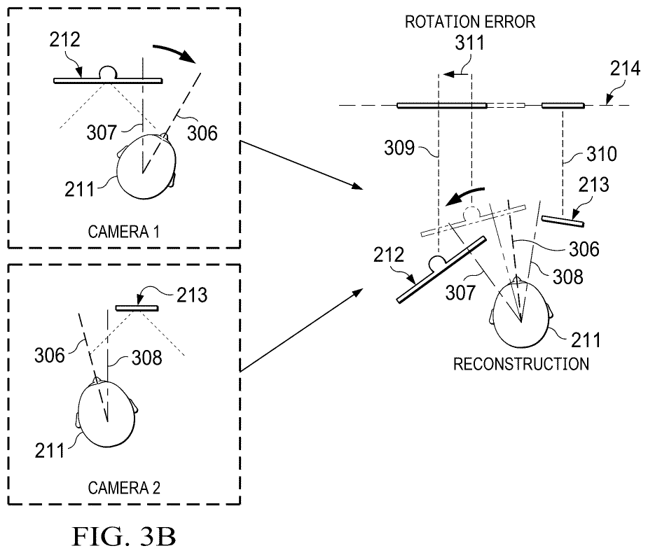

FIGS. 3A and 3B are top down views illustrating reconstruction of a background using the process of FIG. 2, according to one or more embodiments.

Referring to the left side of FIG. 3A, camera 1 on display 212 captures head position 301 of user 211 and camera 2 on display 213 also captures head position 301 of user 211. Arrow 303 represents translation error. Referring to the right side of FIG. 3A representing background reconstruction, the vertical dashed lines 304, 305 for display 212 and display 213, respectively, represent mapping 210 of portions of the background to 2D virtual flat plane 214 represented by a horizontal dashed line in accordance with the respective dimensions 208 of displays 212, 213.

Referring to left side of FIG. 3B, camera 1 captures head orientation 306 of user 211 and camera 2 on display 212 also captures head orientation 306 of user 211. Line segment 307 represents a reference surface normal to display 212 and line segment 308 represents a reference surface normal to display 213. Referring to the right side of FIG. 3B representing background reconstruction, the vertical dashed lines 309, 310 for display 212 and display 213, respectively, represent mapping 210 of portions of the background to 2D virtual flat plane 214 in accordance with the respective dimensions 208 of displays 212, 213. Arrow 311 represents rotation error.

FIG. 4 is a top down view illustrating how the relative position of displays 212, 213 are determined in the head frame, according to one or more embodiments. Displays 212 and 213 are shown together with 2D virtual flat plane 214 (the dashed line). Based on the head poses of user 211 captured by the two cameras, the head pose vectors A and B generated by the face trackers are rotated into the head frame using Equation [1]. In the example shown, the head frame has an origin at the center of the user's head, the +z-axis extends from the user's nose, the +y-axis extends from the user's left ear and the −x-axis extends from the top of the user's head to form a right-handed coordinate system. Other right-handed frames can be used. In some embodiments, the pitch and yaw angles of head pose vectors A and B are used to determine the relative positions of the center of displays 212, 213, respectively. For example, a negative yaw angle A for vector A and a positive yaw angle B for vector B measured from the +z-axis of the head frame would indicate that display 213 is located to the left of display 212. Likewise, a positive pitch angle (not shown) for vector A and a negative pitch angle (not shown) for vector B would indicate that display 213 is located below display 12.

FIG. 5 illustrates mapping a background to multiple displays based on their relative positions to each other and their respective dimensions, according to one or more embodiments. FIG. 5 continues with the example relative position where display 213 (display B) is located to the right of display 212 (display B). The background is shown mapped to and coextensive with a 2D virtual flat plane 214. With knowledge of the dimension of the displays 212, 213, portions of appropriate dimensions 501, 502 are cut-out from 2D virtual flat plane 214 for presentation by the operating system on displays 212 and 213, respectively. Note that when generating cut-outs 501, 502 from virtual flat plane 213, the gap between displays 212, 213 in the real world needs to be respected. In some embodiments, this can be automated with accurate position sensing. For example, if the background includes a human face across the gap, and cut-outs 501, 502 did not account for the gap, the eyes may be too far apart from the perspective of the user and the face too wide or not continuous.

In some embodiments, cut-outs 501, 502 are “snapped” together by the operating system to remove the gap between displays, 212, 213 so that, for example, the cursor does not disappear when the user moves it across the gap. In some embodiments, 2D virtual flat plane 214 can be replaced with a curved surface for improved mapping accuracy since most users tilt their displays inwards.

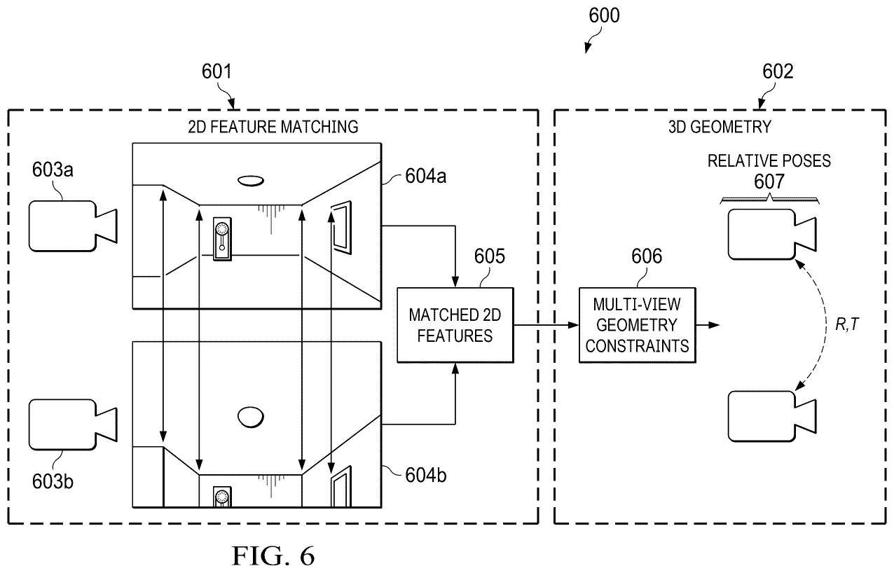

FIG. 6 illustrates an alternative embodiment of display alignment using features in an environment, according to one or more embodiments. In some embodiments, automatic alignment can be made without face tracking. In such embodiments, static features in the environment that are captured by overlapping camera FOVs are used to determine the positions and orientation of displays 212, 213 relative to each other.

Referring to FIG. 6, cameras 603a and 603b capture images 604a and 604b, respectively, of the environment. Features (e.g., static objects) in the environment captured by cameras 603a and 603b are matched 605 in two dimensions (2D). To estimate the depth and relative poses of the displays, multi-view geometry constraints are applied 606 to the 2D matched features. In some embodiments, an epipolar constraint is used to determine the geometric relationship between the points in the two camera views, leveraging the fundamental matrix derived from the intrinsic camera parameters (e.g., focal length, sensor pitch) and the relative extrinsic parameters (rotation and translation) of the cameras. The essential matrix is further used to refine the relative pose estimation. Using these constraints, the system triangulates the matched 2D features to compute their 3D positions, which are then used to determine the relative poses 607 of displays 212 and 213. This process aligns the displays for seamless cursor navigation and background presentation, as shown in FIGS. 1A and 1B. Additionally, the depth is estimated by computing the disparity between corresponding features, allowing for precise alignment even in cases where the displays are tilted or spaced apart.

In some embodiments, the method described above provides a fallback method in the event face tracking fails to approximate the user's head pose (e.g., due to occluded faces, oblique face angles, or other conditions). The fallback method uses environmental features to: capture images of the environment from multiple connected cameras with overlapping fields of view; identify unique features within the overlapping fields of view of the cameras; match the identified unique features across the captured images to establish spatial correspondences; estimate the relative orientation and translation of each camera with respect to a reference coordinate system defined by the primary display based on the matched features; and aligning the connected displays using the estimated relative positions and orientations to provide seamless user interaction and visual continuity.

In some embodiments, a “rubber-band” effect can be applied to the cursor movement at the display boundaries. This effect provides resistance to the cursor movement and prevents the cursor from being accidentally moved to a neighboring display.

In some embodiments, automatic alignment is performed upon a request from the user or in response to detection of an external display being coupled to the computer. If the relative positions of the displays are changed after alignment (e.g., by the user), the change is detected and the user is visually and/or audibly alerted of the change, so that the cameras can be turned on again (if not already on) for automatic alignment. In some embodiments, the changed relative positions of the displays are triggered by motion sensor measurements (e.g., accelerometer, gyros) that detect translation and/or rotation of the displays. In some embodiments, when the external display is connected the cameras are automatically turned on to perform automatic alignment.

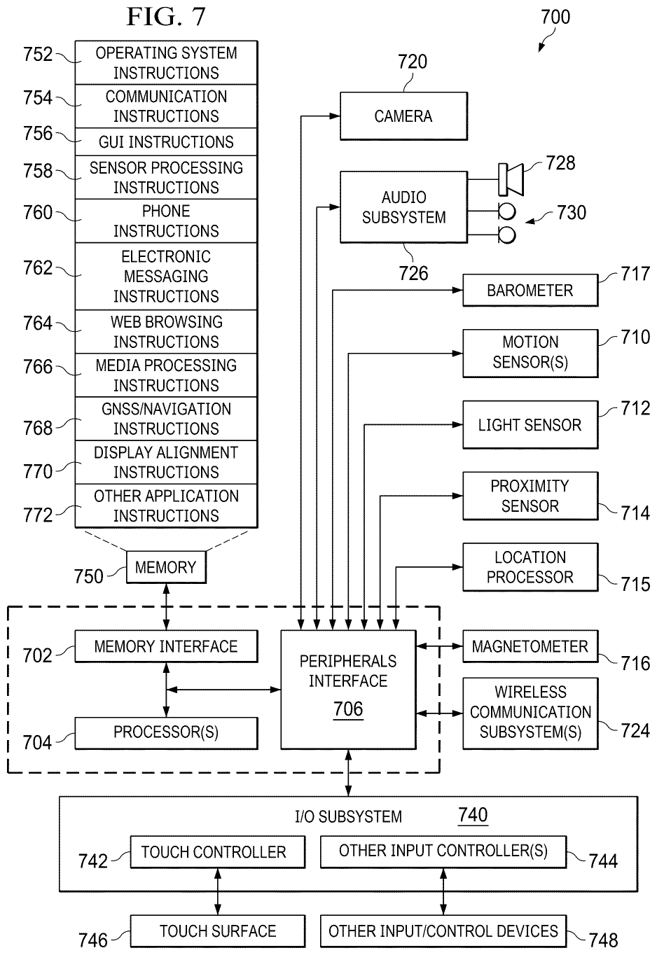

FIG. 7 is a block diagram of a system for implementing the processes described in reference to FIGS. 1-6. System 700 can include memory interface 702, one or more hardware data processors, image processors and/or processors 704 and peripherals interface 706. Memory interface 702, one or more processors 704 and/or peripherals interface 706 can be separate components or can be integrated in one or more integrated circuits. System 700 can be included in any suitable electronic device coupled to a display, including but not limited to desktop computers, notebook computers, tablet computers, and the like.

Sensors, devices, and subsystems can be coupled to peripherals interface 706 to provide multiple functionalities. For example, one or more motion sensors 710, light sensor 712 and proximity sensor 714 can be coupled to peripherals interface 706 to facilitate motion sensing (e.g., acceleration, rotation rates), lighting and proximity functions of the wearable device. Location processor 715 can be connected to peripherals interface 706 to provide geo-positioning. In some implementations, location processor 715 can be a GNSS receiver, such as the Global Positioning System (GPS) receiver. Electronic magnetometer 716 (e.g., an integrated circuit chip) can also be connected to peripherals interface 706 to provide data that can be used to determine the direction of magnetic North. Electronic magnetometer 716 can provide data to an electronic compass application. Motion sensor(s) 710 can include one or more accelerometers and/or gyros configured to determine change of speed and direction of movement. Barometer 717 can be configured to measure atmospheric pressure (e.g., pressure change inside a vehicle). Bio signal sensor 720 can be one or more of a PPG sensor, an electroencephalogram (EEG) sensor, an electrocardiogram (ECG) sensor, an electromyogram (EMG) sensor, a mechanomyogram (MMG) sensor (e.g., piezo resistive sensor) for measuring muscle activity/contractions, an electrooculography (EOG) sensor, a galvanic skin response (GSR) sensor, a magnetoencephalogram (MEG) sensor and/or other suitable sensor(s) configured to measure bio signals.

Communication functions can be facilitated through wireless communication subsystems 724, which can include radio frequency (RF) receivers and transmitters (or transceivers) and/or optical (e.g., infrared) receivers and transmitters. The specific design and implementation of the communication subsystem 724 can depend on the communication network(s) over which a mobile device is intended to operate. For example, architecture 700 can include communication subsystems 724 designed to operate over a GSM network, a GPRS network, an EDGE network, a WiFi™ network and a Bluetooth™ network. In particular, the wireless communication subsystems 724 can include hosting protocols, such that the crash device can be configured as a base station for other wireless devices.

Audio subsystem 726 can be coupled to a speaker 728 and a microphone 730 to facilitate voice-enabled functions, such as voice recognition, voice replication, digital recording and telephony functions. Audio subsystem 726 can be configured to receive voice commands from the user.

I/O subsystem 740 can include touch surface controller 742 and/or other input controller(s) 744. Touch surface controller 742 can be coupled to a touch surface 746. Touch surface 746 and touch surface controller 742 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch surface 746. Touch surface 746 can include, for example, a touch screen or touch pad. I/O subsystem 740 can include a haptic engine or device for providing haptic feedback (e.g., vibration) in response to commands from processor 704. In an embodiment, touch surface 746 can be a pressure-sensitive surface.

Other input controller(s) 744 can be coupled to other input/control devices 748, such as one or more buttons, rocker switches, thumbwheel, infrared port, and USB port. Touch surface 746 or other controllers 744 (e.g., a button) can include, or be coupled to, fingerprint identification circuitry for use with a fingerprint authentication application to authenticate a user based on their fingerprint(s).

In one implementation, a pressing of the button for a first duration may disengage a lock of the touch surface 746; and a pressing of the button for a second duration that is longer than the first duration may turn power to the mobile device on or off. The user may be able to customize a functionality of one or more of the buttons. The touch surface 746 can, for example, also be used to implement virtual or soft buttons.

In some implementations, the mobile device can present recorded audio and/or video files, such as MP3, AAC and MPEG files. In some implementations, the mobile device can include the functionality of an MP3 player. Other input/output and control devices can also be used.

Memory interface 702 can be coupled to memory 750. Memory 750 can include high-speed random-access memory and/or non-volatile memory, such as one or more magnetic disk storage devices, one or more optical storage devices and/or flash memory (e.g., NAND, NOR). Memory 750 can store operating system 752, such as the iOS operating system developed by Apple Inc. of Cupertino, California. Operating system 752 may include instructions for handling basic system services and for performing hardware dependent tasks. In some implementations, operating system 752 can include a kernel (e.g., UNIX kernel).

Memory 750 may also store communication instructions 754 to facilitate communicating with one or more additional devices, one or more computers and/or one or more servers, such as, for example, instructions for implementing a software stack for wired or wireless communications with other devices. Memory 750 may include graphical user interface instructions 756 to facilitate graphic user interface processing; sensor processing instructions 758 to facilitate sensor-related processing and functions; phone instructions 760 to facilitate phone-related processes and functions; electronic messaging instructions 762 to facilitate electronic-messaging related processes and functions; web browsing instructions 764 to facilitate web browsing-related processes and functions; media processing instructions 766 to facilitate media processing-related processes and functions; GNSS/Location instructions 768 to facilitate generic GNSS and location-related processes and instructions; and display alignment instructions 770 that implement the processes described in reference to FIGS. 1-6. Memory 750 further includes other application instructions 772 including but not limited to instructions for applications that use the features and processed described in reference to FIGS. 1-6.

Each of the above identified instructions and applications can correspond to a set of instructions for performing one or more functions described above. These instructions need not be implemented as separate software programs, procedures, or modules. Memory 750 can include additional instructions or fewer instructions. Furthermore, various functions of the mobile device may be implemented in hardware and/or in software, including in one or more signal processing and/or application specific integrated circuits.

As described above, some aspects of the subject matter of this specification include gathering and use of data available from various sources to improve services a mobile device can provide to a user. The present disclosure contemplates that in some instances, this gathered data may identify a particular location or an address based on device usage. Such personal information data can include location-based data, addresses, subscriber account identifiers, or other identifying information.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In the case of advertisement delivery services, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

What is claimed is:

1. A method comprising:
capturing, with a first camera of a first display, a first image;
capturing, with a second camera of a second display, a second image, where the respective fields of view for the first camera and the second camera are at least partially overlapped;
transforming, with at least one processor, the first head pose into a first reference frame for the first display;
transforming, with the at least one processor, the second head pose into a second reference frame for the second display;
generating, with the at least one processor, a dual-display environment for the first and second displays based on the first and second head poses in the first and second reference frames, respectively;
presenting, with the at least one processor, a first portion of the dual-display environment on the first display; and
presenting, with the at least one processor, a second portion of the dual-display environment on the second display.

2. The method of claim 1, further comprising:
presenting, with the at least one processor, a first portion of wallpaper or screensaver on the first display; and
presenting, with the at least one processor, a second portion of the wallpaper or screensaver on the second display.

3. The method of claim 1, where the first display and second display are side by side.

4. The method of claim 1, wherein the first display is a desktop computer display with a first set of dimensions and the second display is a notebook computer display with a second set of dimensions that are smaller than the first set of dimensions.

5. The method of claim 1, wherein transforming the first head pose into the first reference frame for the first display, and transforming the second head pose into the second reference frame for the second display comprises:
for the first display:
transforming the first head pose into a first camera frame;
obtaining a head frame to first camera frame transformation using intrinsic parameters of the first camera;
inverting the head frame to first camera frame transformation into a first camera frame to head frame transformation;
obtaining a first display frame to first camera frame transformation using extrinsic parameters of the first display;
obtaining a first display frame to head frame transformation based on the first camera frame to head frame transformation and the first display frame to first camera frame transformation;
transforming, using the first display frame to head frame transformation, the first head pose into the head frame;
for the second display:
transforming the second head pose into a second camera frame;
obtaining a head frame to second camera frame transformation using intrinsic parameters of the second camera;
inverting the head frame to second camera frame transformation into a second camera frame to head frame transformation;
obtaining a second display frame to second camera frame transformation using extrinsic parameters of the second display;
obtaining a second display frame to head frame transformation based on the second camera frame to head frame transformation and the second display frame to second camera frame transformation;
transforming, using the second display frame to head frame transformation, the first head pose into the head frame;
determining relative positions of centers of the first and second displays in the head frame based on positions and orientations of the first and second head poses in the head frame;
mapping a background image to a two-dimensional (2D) virtual flat plane based on the relative positions of the first and second displays and their respective dimensions;
cutting out a first portion of the 2D virtual flat plane based on a first set of dimensions of the first display;
cutting out a second portion of the 2D virtual flat plane based on a second set of dimensions of the second display; and
presenting the first portion on the first display and the second portion on the second display.

6. The method of claim 5, wherein determining relative positions of centers of the first and second displays in the head frame based on positions and orientations of the first and second head poses in the head frame includes determining angles of head pose vectors in the head frame that point from the head to the centers of the first and second displays.

7. The method of claim 5, wherein a gap between the first and second displays is removed during the cutting of the first and second portions from the 2D virtual flat plane.

8. A system comprising:
at least one processor;
memory storing instruction that when executed by the at least one processor, causes the at least one processor to perform operations comprising:
capturing images of an environment from multiple cameras with overlapping fields of view, where a first camera is associated with a primary display and a second camera is associated with a secondary display;
identifying unique features within the overlapping fields of view of the cameras;
matching the identified unique features across the captured images to establish spatial correspondences;
estimating a relative orientation and translation of each camera with respect to a reference coordinate system defined by the primary display based on the matched features; and
aligning the primary display with the secondary display using the estimated relative positions and orientations of the primary and secondary displays.

9. The system of claim 8, further comprising:
presenting, with the at least one processor, a first portion of wallpaper or screensaver on the first display; and
presenting, with the at least one processor, a second portion of the wallpaper or screensaver on the second display.

10. The system of claim 8, where the first display and second display are side by side.

11. The system of claim 10, wherein the first display is a desktop computer display with a first set of dimensions and the second display is a notebook computer display with a second set of dimensions that are smaller than the first set of dimensions.

12. The system of claim 8, wherein transforming the first head pose into a first reference frame for the first display, and transforming the second head pose into a second reference frame for the second display comprises:
for the first display:
transforming the first head pose into a first camera frame;
obtaining a head frame to first camera frame transformation using intrinsic parameters of the first camera;
inverting the head frame to first camera frame transformation into a first camera frame to head frame transformation;
obtaining a first display frame to first camera frame transformation using extrinsic parameters of the first display;
obtaining a first display frame to head frame transformation based on the first camera frame to head frame transformation and the first display frame to first camera frame transformation;
transforming, using the first display frame to head frame transformation, the first head pose into the head frame;
for the second display:
transforming the second head pose into a second camera frame;
obtaining a head frame to second camera frame transformation using intrinsic parameters of the second camera;
inverting the head frame to second camera frame transformation into a second camera frame to head frame transformation;
obtaining a second display frame to second camera frame transformation using extrinsic parameters of the second display;
obtaining a second display frame to head frame transformation based on the second camera frame to head frame transformation and the second display frame to second camera frame transformation;
transforming, using the second display frame to head frame transformation, the first head pose into the head frame;
determining a relative position of the first and second displays in the head frame based on positions and orientations of the first and second head poses in the head frame;
mapping a background image to a two-dimensional (2D) virtual flat plane based on the relative positions of the first and second displays and their respective dimensions;
cutting out a first portion of the 2D virtual flat plane based on the dimensions of the first display;
cutting out a second portion of the 2D virtual flat plane based on the dimensions of the second display; and
presenting the first portion on the first display and the second portion on the second display.

13. The system of claim 12, wherein angles of head pose vectors in the head frame are used to determine the relative positions of the center of the first and second displays.

14. The system of claim 12, wherein a gap between the first and second displays is removed during the cutting of the first and second portions from the 2D virtual flat plane.

15. A method comprising:
capturing images of an environment from multiple cameras with overlapping fields of view, where a first camera is associated with a primary display and a second camera is associated with a secondary display;
identifying unique features within the overlapping fields of view of the cameras;
matching the identified unique features across the captured images to establish spatial correspondences;
estimating a relative orientation and translation of each camera with respect to a reference coordinate system defined by the primary display based on the matched features; and
aligning the primary display with the secondary display using the estimated relative positions and orientations of the primary and secondary displays.

16. The method of claim 15, wherein the unique features are matched in two dimensions (2D) to estimate depth and relative pose of each display and the method further comprises:
applying multi-view geometry constraints to the 2D matched features; and
triangulating the 2D matched features to compute three-dimensional (3D) positions of the matched 2D features; and
determining relative poses of the displays based on the 3D positions of the matched 2D features.

17. A system comprising:
at least one processor;
memory storing instruction that when executed by the at least one processor, causes the at least one processor to perform operations comprising:
capturing images of an environment from multiple cameras with overlapping fields of view, where a first camera is associated with a primary display and a second camera is associated with a secondary display;
identifying unique features within the overlapping fields of view of the cameras;
matching the identified unique features across the captured images to establish spatial correspondences;
estimating a relative orientation and translation of each camera with respect to a reference coordinate system defined by the primary display based on the matched features; and
aligning the primary display with the secondary display using the estimated relative positions and orientations of the primary and secondary displays.

18. The system of claim 17, wherein the unique features are matched in two dimensions (2D) to estimate depth and relative pose of each display and the method further comprises:
applying multi-view geometry constraints to the 2D matched features; and
triangulating the 2D matched features to compute three-dimensional (3D) positions of the matched 2D features; and
determining relative poses of the displays based on the 3D positions of the matched 2D features.
